(19) United States
(12) Patent Application Publication
(10) Pub. No.: US 2026/0032089 A1
(43) Pub. Date: Jan. 29, 2026

(54) SCHEDULING METHOD AND CONTROL DEVICE

(71) Applicant: NIPPON TELEGRAPH AND TELEPHONE CORPORATION, Tokyo (JP)

(72) Inventors: Takahiro KUBO, Tokyo (JP); Yuhei KAWAKAMI, Tokyo (JP); Hironao ABE, Tokyo (JP); Natsuki YASUHARA, Tokyo (JP); Hideo KAWATA, Tokyo (JP); Shinichi YOSHIHARA, Tokyo (JP)

(73) Assignee: NIPPON TELEGRAPH AND TELEPHONE CORPORATION, Tokyo (JP)

(21) Appl. No.: 18/992,943

(22) PCT Filed: Jul. 11, 2022
(86) PCT No.: PCT/JP2022/027282

§ 371 Date: Jan. 9, 2025

(51) Int. Cl. H04L 47/24; H04L 47/76; H04L 49/35

(52) U.S. Cl. CPC H04L 47/24; H04L 47/76; H04L 49/35

(57) ABSTRACT

A control device (10) according to the present disclosure includes a control unit (12), wherein the control unit (12) judges whether or not there is fragmentation at an exit port of one switch on the basis of a transmission schedule of priority traffic in each of a plurality of switches, judges whether or not there is movable traffic among the priority traffic transmitted at the exit port of one switch when judging that there is the fragmentation, judges whether or not the fragmentation is reduced as a whole network (2) by a change in the transmission schedule in each of the plurality of switches along with the change in transmission timing of movable traffic when judging there is the movable traffic, and changes the transmission schedule in each of the plurality of switches when judging that the fragmentation is reduced as the whole network (2).

### TECHNICAL FIELD

The present disclosure relates to a scheduling method and a control device.

### BACKGROUND ART

A communication system has been studied, in which Time Aware Shaper (TAS), that is time-fixed type communication, is introduced and scheduled traffic (hereinafter referred to as “priority traffic”) of a plurality of users is transferred on a layer 2 network with low delay and low jitter. TAS schedules so that the priority traffic is transferred without colliding them in the network (see NPL 1).

FIG. 11 is a diagram showing one example of a communication system 1a in which TAS is introduced. In an example shown in FIG. 11, four switches SW1 to SW4 are provided on the network 2. The switch SW3 is connected to each of the switches SW1, SW2, and SW4. The priority traffic of each of Talker #1 to Talker #4 is transferred to a Listener #5 or a Listener #6 via the switches SW1 to SW4.

In TAS, transmission timing for transmitting the priority traffic from each exit port (Egress port) of the switches SW1 to SW4 is scheduled. FIG. 12 is a diagram showing one example of a transmission schedule of the priority traffic of each of the Talker #1 to Talker #4 in the communication system 1a shown in FIG. 11.

In the example shown in FIG. 12, it is scheduled that the priority traffic of the Talker #1 and Talker #2 is transmitted to an exit port a from the switch SW1 to the switch SW3 in this order, the priority traffic of the Talker #3, Talker #4, and Talker #2 is transmitted to an exit port b from the switch SW2 to the switch SW3 in this order, and the priority traffic of the Talker #1, Talker #3, Talker #4, and Talker #2 is transmitted to an exit port c from the switch SW3 to the switch SW4.

### CITATION LIST

### Non Patent Literature

[NPL 1] IEEE Standard for Local and Metropolitan Area Networks—Bridges and Bridged Networks IEEE std 802.10-2018

### SUMMARY OF INVENTION

### Technical Problem

In the communication system shown in FIG. 11, not only the priority traffic but also traffic composed of frame sequences transmitted on a best-effort basis (hereinafter referred to as “BE traffic”) is transmitted. Specifically, as shown in FIG. 12, the BE traffic is transmitted within a predetermined time (cycle time) at the remaining time when no priority traffic is transmitted.

The communication on the network changes every moment by registration and abolishment of a user. In the example shown in FIG. 12, for example, when the communication of Talker #4 is abolished, as shown in FIG. 13A, a vacant space is generated in a portion where the transmission of the priority traffic of Talker #4 was scheduled. When the vacant space is generated in the transmission schedule of priority traffic, a time allocatable to the transmission of BE traffic does not change even though there is a time zone in which the priority traffic is not transmitted while a time region for transmitting multiple priority traffic remains constant within the cycle time, there is a problem that the efficiency of data transfer cannot be improved. That is, as shown in FIG. 13B, when the vacant space is generated in the transmission schedule of priority traffic, if the time allocatable to the transmission of BE traffic can be increased by reducing the transmission interval of priority traffic, thus, the efficiency of data transfer can be improved.

Therefore, in order to improve the transfer efficiency of BE traffic, it is conceivable to review the transmission schedule at each port of all the priority traffic existing after the update and change the transmission schedule every time the priority traffic is updated by adding or abolishing the user. However, for example, in the network provided by a telecommunications carrier, if the transmission schedule of all the priority traffic is changed each time the user is added or abolished, a large computational resource cost is required. Further, if a calculation time for reviewing the transmission schedule of priority traffic becomes longer than the update period of priority traffic, there is a possibility that optimization of improving the transfer efficiency of BE traffic cannot be performed normally.

An object of the present invention made in view of the above-mentioned problems is to provide a scheduling method and a control device capable of improving efficiency of data transfer while suppressing an increase in costs.

### Solution to Problem

In order to solve the above-mentioned problem, a scheduling method according to the present disclosure is the scheduling method of a transmission schedule of priority traffic in a network in which transmission timing by switches is reserved and the priority traffic composed of frame sequences transmitted while guaranteeing the maximum delay is transferred through a plurality of switches, and includes the steps of acquiring the transmission schedule of priority traffic in each of the plurality of switches, judging whether or not there is fragmentation in which an interval equal to or greater than a predetermined value is provided between the transmission timing of one priority traffic and the transmission timing of next priority traffic at an exit port of one switch on the basis of the acquired transmission schedule, judging whether or not there is movable traffic capable of reducing the interval by performing defragmentation for changing the transmission timing among the priority traffic transmitted at the exit port of the one switch when judging that there is the fragmentation, judging whether or not the fragmentation is reduced as a whole network by a change in the transmission schedule in each of the plurality of switches along with the change in the transmission timing of movable traffic when judging that there is the movable traffic, and changing the transmission schedule in each of the plurality of switches when judging that the fragmentation is reduced as the whole network.

In order to solve the above-mentioned problem, a control device according to the present disclosure is the control device that controls a transmission schedule of priority traffic in a network in which transmission timing by switches is reserved and the priority traffic composed of frame sequences transmitted while guaranteeing the maximum delay is transferred through a plurality of switches, and includes a control unit, wherein the control unit judges whether or not there is fragmentation in which an interval equal to or greater than a predetermined value is provided between the transmission timing of one priority traffic and the transmission timing of next priority traffic at an exit port of one switch on the basis of the transmission schedule of priority traffic in each of the plurality of switches, judges whether or not there is movable traffic capable of reducing the interval by performing defragmentation for changing the transmission timing among the priority traffic transmitted at the exit port of the one switch when judging that there is the fragmentation, judges whether or not the fragmentation is reduced as a whole network by a change in the transmission schedule in each of the plurality of switches along with the change in the transmission timing of movable traffic when judging that there is the movable traffic, and changes the transmission schedule in each of the plurality of switches when judging that the fragmentation is reduced as the whole network.

### Advantageous Effects of Invention

According to the scheduling method and the control device according to the present disclosure, it is possible to improve the efficiency of data transfer while suppressing an increase in cost.

### BRIEF DESCRIPTION OF DRAWINGS

FIG. 1 is a diagram showing a configuration example of a communication system to which a control device is applied according to one embodiment of the present disclosure.

FIG. 2 is a diagram showing a configuration example of the control device shown in FIG. 1.

FIG. 3 is a diagram showing one example of transfer of priority traffic by a plurality of switches.

FIG. 4 is a flowchart showing one example of an operation of a control unit shown in FIG. 2.

FIG. 5 is a diagram showing one example of a scheduling matrix created by the control unit shown in FIG. 2.

FIG. 6 is a diagram showing one example of a change of a transmission schedule by the control unit shown in FIG. 2.

FIG. 7 is a diagram showing the other one example of transfer of the priority traffic by the plurality of switches.

FIG. 8 is a diagram showing an example of collision of the priority traffic.

FIG. 9 is a diagram showing the other one example of a change of the transmission schedule by the control unit shown in FIG. 2.

FIG. 10 is a diagram showing one example of a hardware configuration of the control device according to the present disclosure.

FIG. 11 is a diagram showing a configuration example of a conventional communication system.

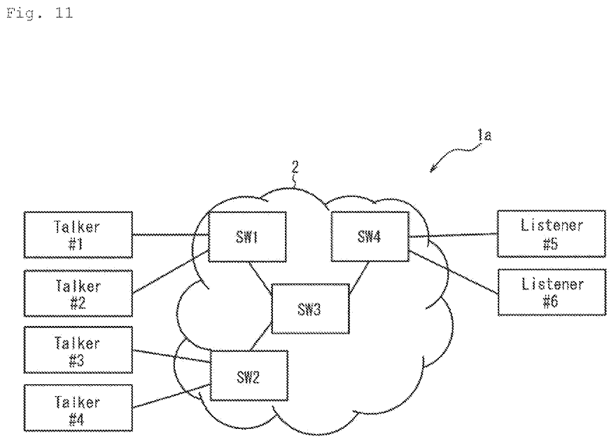

FIG. 12 is a diagram showing one example of a transmission schedule of priority traffic in the communication system shown in FIG. 11.

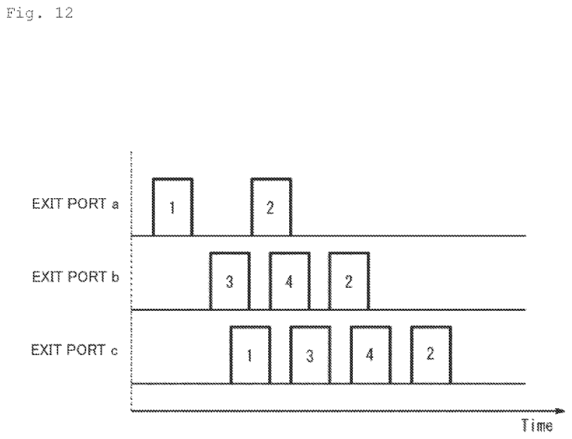

FIG. 13A is a diagram showing one example of a transmission schedule of priority traffic when the communication of a user is abolished in the communication system shown in FIG. 11.

FIG. 13B is a diagram showing one example of a change of the transmission schedule shown in FIG. 13A.

### DESCRIPTION OF EMBODIMENTS

Hereinafter, embodiments of the present disclosure will be described with reference to the drawings.

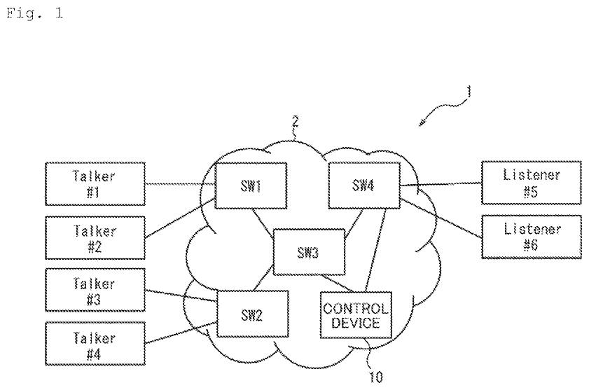

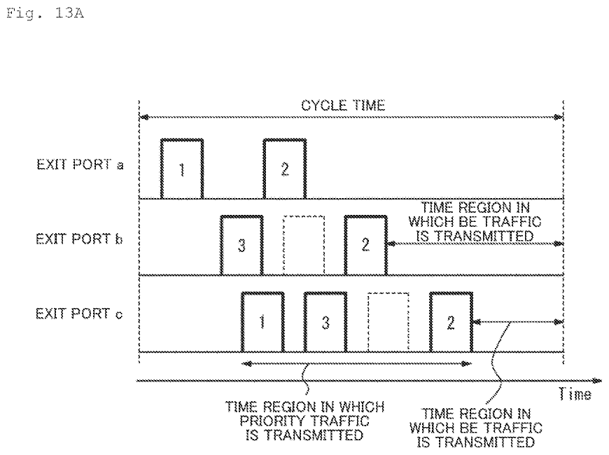

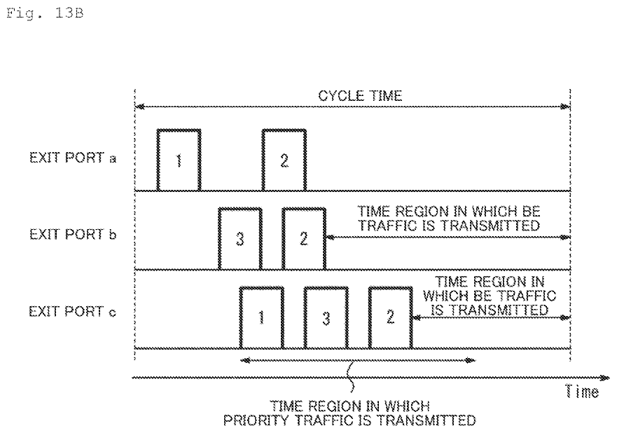

FIG. 1 is a diagram showing a configuration example of a communication system 1 to which a control device 10 is applied according to one embodiment of the present disclosure. As shown in FIG. 1, the communication system 1 includes a plurality of switches SW (switches SW1 to SW4) and a control device 10 provided on a network 2. Data is transferred from a transmission source to a transmission destination by the plurality of switches SW1 to SW4. In this embodiment, it is assumed that transmission timing by the switches SW1 to SW4 is reserved, and priority traffic composed of frame sequences transmitted while guaranteeing the maximum delay and traffic (BE traffic) composed of frame sequences transmitted on a best-effort basis are transmitted. As described with reference to FIG. 13, the BE traffic is transmitted within a predetermined time (cycle time) at the remaining time when the priority traffic is not transmitted.

The control device 10 according to the present embodiment is connected to each of the switches SW1 to SW4, and controls a transmission schedule of priority traffic by each of the switches SW1 to SW4. Although FIG. 1 shows an example in which the control device 10 is provided separately from the switches SW1 to SW4, but it is not limited to this. In the communication system 1 shown in FIG. 1, the switches SW1 to SW4 may be provided with an autonomous control function, respectively. In this case, the control device 10 may be mounted on one or two or more switches SW, for example. Hereinafter, on the assumption that the control device 10 is provided separately from the switches SW1 to SW4 as shown in FIG. 1, the description will be performed.

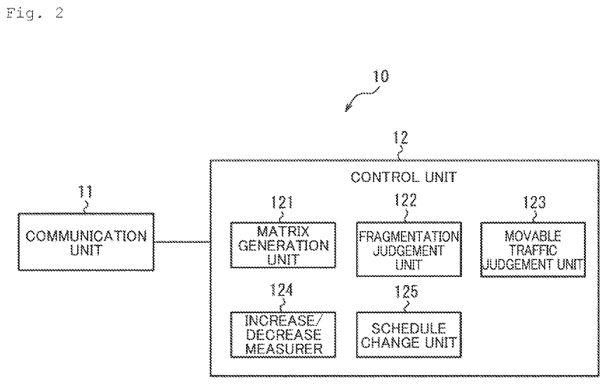

FIG. 2 is a diagram showing a configuration example of the control device 10 according to the present embodiment.

As shown in FIG. 2, the control device 10 according to the present embodiment includes a communication unit 11 and a control unit 12.

The communication unit 11 can communicate with each of the plurality of switches SW1 to SW4 on the network 2. The communication unit 11 can transmit/receive the transmission schedule of priority traffic to/from each of the switches SW1 to SW4, for example.

The control unit 12 acquires the transmission schedule of priority traffic in each of the plurality of switches SW1 to SW4 via the communication unit 11. The control unit 12 judges whether or not it is necessary to change the transmission schedule of the priority traffic on the basis of the acquired transmission schedule. The control unit 12 changes the transmission schedule of the priority traffic in each of the plurality of switches SW1 to SW4, and transmits the transmission schedule after change to each of the plurality of switches SW1 to SW4 via the communication unit 11, when judging that it is necessary to change the transmission schedule of the priority traffic.

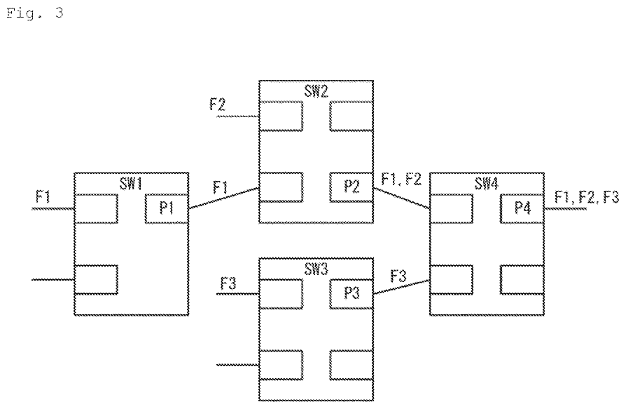

As shown in FIG. 2, the control unit 12 includes a matrix generation unit 121, a fragmentation judgement unit 122, a movable traffic judgement unit 123, an increase/decrease measurement unit 124, and a schedule change unit 125. The operation of each unit of the control unit 12 will be described in more detail. Hereinafter, as shown in FIG. 3, it is assumed that priority traffic F1 is transmitted from an exit port P1 of the switch SW1 to the switch SW2, priority traffic F1 and priority traffic F2 are transmitted from an exit port P2 of the switch SW2 to the switch SW4, priority traffic F3 is transmitted from an exit port P3 of the switch SW3 to the switch SW4, priority traffic F1, priority traffic F2, and priority traffic F3 are transmitted from an exit port P4 of the switch SW4.

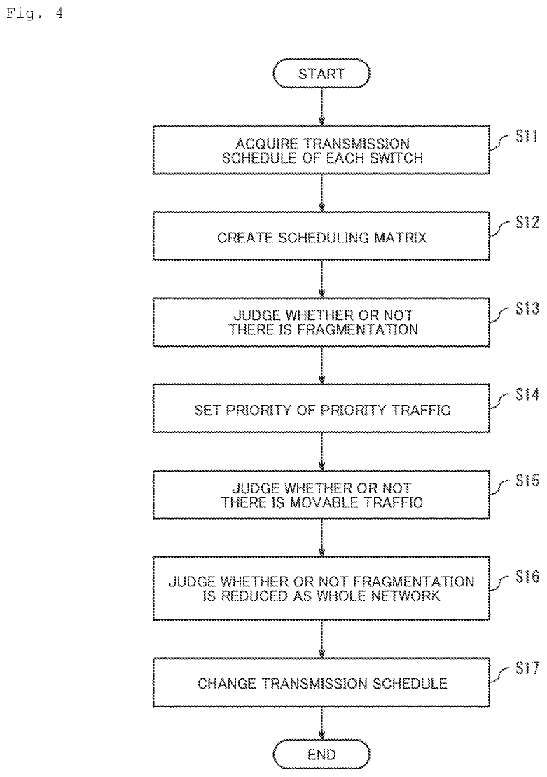

FIG. 4 is a flowchart showing one example of the operation of the control unit 12, and is a diagram for explaining a scheduling method by the control device 10 according to the present embodiment.

The matrix generation unit 121 acquires the transmission schedule of priority traffic in each of the plurality of switches SW on the network 2 via the communication unit 11 (step S11). The control unit 12 acquires the transmission schedule of the switch SW to be scheduled. Hereinafter, on the assumption that the control unit 12 has acquired the transmission schedules of the switch SW1 (exit port P1), the switch SW2 (exit port P2), the switch SW3 (exit port P3), and the switch SW4 (exit port P4), the description will be performed.

The matrix generation unit 121 creates a scheduling matrix M shown in Expression (1) on the basis of the acquired transmission schedule.

$$[ Math . 1 ]$$

$$M = ( \begin{matrix}{M}_{11} & … & {M}_{1 n} \\ ⋮ & ⋱ & ⋮ \\ {M}_{m 1} & … & {M}_{mn}\end{matrix} ) \qquad Expression ( 1 )$$

Here, each row of the scheduling matrix M corresponds to the exit port of the switch SW existing in the network to be controlled, and each column corresponds to the transmission timing of the frame of priority traffic. An arbitrary element Mᵢⱼ (1?i?m, 1?j?n) in the scheduling matrix M has a non-zero element when the priority traffic is reserved, and becomes zero when the priority traffic is not reserved. Expression (2) is one example of the scheduling matrix paying attention to the exit ports P1, P2, P3, and P4 of the network shown in FIG. 3.

$$( \begin{matrix}{f}_{1} & 0 & 0 & 0 & 0 & 0 & 0 \\ 0 & {f}_{1} & {f}_{2} & 0 & 0 & 0 & 0 \\ 0 & 0 & 0 & 0 & 0 & {f}_{3} & 0 \\ 0 & 0 & {f}_{1} & {f}_{2} & 0 & 0 & {f}_{3}\end{matrix} ) \qquad [ Math . 2 ]$$

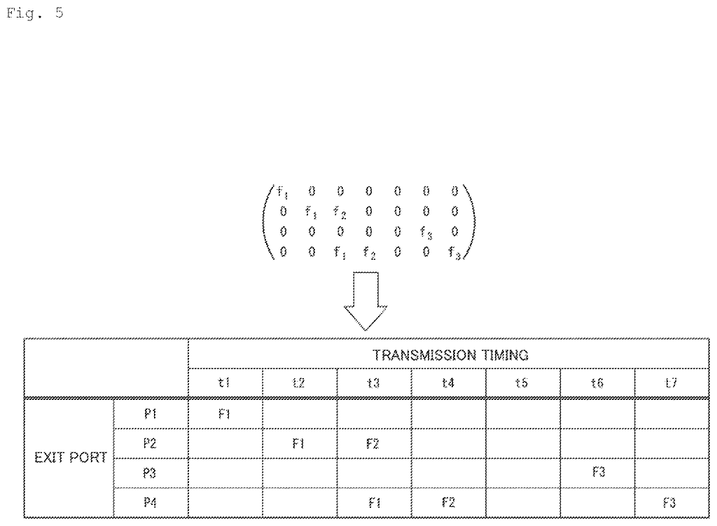

FIG. 5 is a table showing the output port and the transmission timing of each priority traffic, which is created on the basis of the scheduling matrix shown in Expression (2).

The switches SW1 to SW4 transmit the priority traffic at every predetermined transmission timing (t1 to t7) in the synchronized scheduling period. The matrix generation unit 121 creates the scheduling matrix indicating the transmission timing of priority traffic for each exit port. In the example shown in FIG. 5, the priority traffic F1 is transmitted from the exit port P1 at the transmission timing t1. From the exit port P2, the priority traffic F1 is transmitted at the transmission timing t2, and the priority traffic F2 is transmitted at the transmission timing t3. From the exit port P3, the priority traffic F3 is transmitted at the transmission timing t6. From the exit port P4, the priority traffic F1 is transmitted at the transmission timing t3, the priority traffic F2 is transmitted at the transmission timing t4, and the priority traffic F3 is transmitted at the transmission timing t7.

Referring again to FIG. 4, the fragmentation judgement unit 122 judges whether or not there is fragmentation in which an interval equal to or more than a predetermined value is provided between the transmission timing of one priority traffic and the transmission timing of next priority traffic at the exit port of one switch SW on the basis of the acquired transmission schedule (table shown in FIG. 5) (step S13). Specifically, the control unit 12 refers to the transmission schedule created on the basis of the acquired transmission schedule, and judges whether or not there is a vacant space of one or more transmission timing between the transmission timing of one priority traffic and the transmission timing of next priority traffic at an exit port of one switch SW.

As one example of a method for judging whether or not there is the vacant space of transmission timing, a method for searching the specific row of the scheduling matrix and judging whether or not an element of 0 exists between elements in which the priority traffic is stored is considered.

The fragmentation judgement unit 122 judges whether or not there is the fragmentation in order from the exit port having a larger number of scheduled priority traffic among a plurality of exit ports included in the scheduling matrix. In the example shown in FIG. 5, one priority traffic is scheduled for the exit port P1, two priority traffic are scheduled for the exit port P2, one priority traffic is scheduled for the exit port P3, and three priority traffic are scheduled for the exit port P4. Therefore, the control unit 12 judges whether or not there is the fragmentation from the exit port P4. As shown in FIG. 5, in the exit port P4, since the transmission timing (transmission timing t5 and transmission timing t6) of priority traffic for two times are vacant between the transmission timing t4 of priority traffic F2 and the transmission timing t7 of priority traffic F3, the control unit 12 judges that there is the fragmentation. Hereinafter, the exit port judged that there is the fragmentation (exit port P4 in the example shown in FIG. 5) is referred to as a target exit port. Note that the control unit 12 judges whether or not there is the fragmentation in the exit port P2 having a larger number of scheduled priority traffic next to the exit port P4, when judging that there is no fragmentation in the exit port P4.

The fragmentation judgement unit 122 may judges whether or not there is the fragmentation, for example, when new priority traffic to be transferred via the network 2 is added. In addition, the fragmentation judgement unit 122 may judge whether or not there is the fragmentation, for example, when existing priority traffic is deleted. Further, the fragmentation judgement unit 122 may regularly judges whether or not there is the fragmentation.

The movable traffic judgement unit 123 sets priority of priority traffic for changing the transmission timing in order to perform defragmentation at a target exit port (one exit port) (step S14), when the fragmentation judgement unit 122 judges that there is the fragmentation. Then, the control unit 12 judges whether or not there is the priority traffic (hereinafter, referred to as “movable traffic”) capable of reducing the interval of the transmission timing of priority traffic by performing the defragmentation for changing the transmission timing among the priority traffic transmitted at the target exit port (Step S15).

The movable traffic judgement unit 123 sets the priority traffic higher as the transmission timing is separated from an average of the transmission timing of all priority traffic transmitted from the target exit port within the cycle time, for example. Then, the movable traffic judgement unit 123 judges whether or not the priority traffic is movable traffic from the priority traffic with high priority. As described above, in the example shown in FIG. 5, the exit port P4 is the target exit port, the priority traffic F1 is transmitted at the transmission timing t3, the priority traffic F2 is transmitted at the transmission timing t4, and the priority traffic is transmitted at the transmission timing t7 from the exit port P4. When the transmission timing t1 to t7 are equal intervals, as one example of a setting method of the priority of priority traffic to be moved in order to eliminate the fragmentation, a method of obtaining the average value of transmission timing of priority traffic in each row of the scheduling matrix and preferentially changing the transmission timing from the priority traffic farthest from the average is considered. Taking the exit port P4 of FIG. 5 as an example, the average value of the transmission timing is obtained by (t3+t4+t7)/3.

The movable traffic judgement unit 123 compares a difference between the average value of obtained transmission timing and the transmission timing of each priority traffic, and preferentially judges whether or not the traffic is movable from the priority traffic having a large difference.

The movable traffic judgement unit 123 may judge whether or not the priority traffic is movable traffic from the priority traffic in which the transmission timing is not included in a cluster of transmission timing of two or more consecutive priority traffic among the priority traffic transmitted from the target exit port. In the example shown in FIG. 5, the priority traffic F1 is transmitted at the transmission timing t3, and the priority traffic F2 is transmitted at the transmission timing t4 following the transmission timing t3 in the exit port P4. Then, the transmission timing t7 of the priority traffic F3 is not included in the cluster (transmission timing t3 and transmission timing t4) of transmission timing at which the priority traffic F1 and priority traffic F2 are continuously transmitted. Therefore, the movable traffic judgement unit 123 may judge whether or not the traffic is preferentially movable traffic from the priority traffic F3.

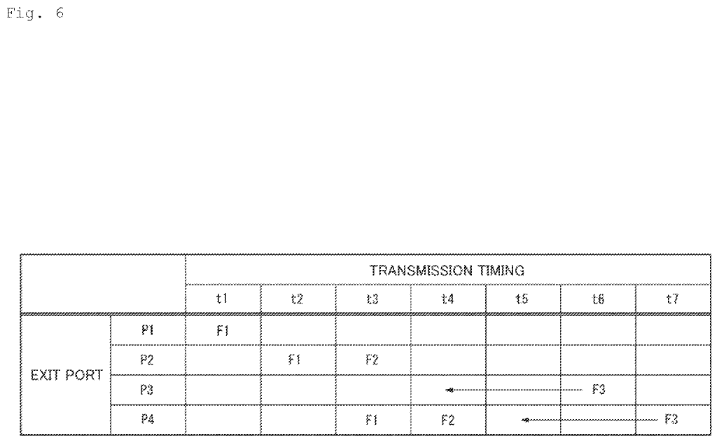

As shown in FIG. 5, the transmission of priority traffic is not scheduled at the transmission timing t5 and the transmission timing t6 between the transmission timing t4 of the priority traffic F2 and the transmission timing t7 of the priority traffic F3, and the transmission timing of priority traffic F3 can be advanced. Therefore, the movable traffic judgement unit 123 judges that the priority traffic F3 is movable traffic, and, for example, as shown in FIG. 6, it is assumed that the transmission timing of priority traffic F3 is changed to the transmission timing t5 immediately after the transmission timing t4 at which the priority traffic F2 is transmitted.

The movable traffic judgement unit 123 judges whether or not the fragmentation is reduced as the whole network 2 by a change of the transmission schedule in each of the plurality of switches SW along with the change of the transmission timing of movable traffic (step S16), when judging that there is the movable traffic.

Specifically, the movable traffic judgement unit 123 changes the transmission timing of movable traffic at the other exit port in association with the change of the transmission timing of movable traffic at the target exit port. As described above, the movable traffic judgement unit 123 assumes that the transmission timing of priority traffic F3 which is the movable traffic is changed from the transmission timing t7 to the transmission timing t5. In this case, the switch SW3 in the preceding stage of the switch SW4 needs to transmit the priority traffic F3 to the switch SW4 before the transmission timing t5. Therefore, the movable traffic judgement unit 123 assumes that the transmission timing of the priority traffic F3 in the switch SW3 is changed from the transmission timing t6 to the transmission timing t4 as shown in FIG. 6. Here, in the switch SW3, the transmission of priority traffic is not scheduled at the transmission timing t4, and even if the priority traffic F3 is transmitted at the transmission timing t4, collision with the other priority traffic does not occur. Therefore, the movable traffic judgement unit 123 judges that the transmission timing of priority traffic F3 can be changed from the transmission timing t6 to the transmission timing t4 in the switch SW3.

The increase/decrease measurement unit 124 judges whether or not the fragmentation is reduced as the whole network 2 when the transmission timing of movable traffic is changed at the other exit port without colliding with the other priority traffic in association with the change of the transmission timing of movable traffic at the target exit port. In the example shown in FIG. 6, no new fragmentation occurs as compared with before the transmission scheduling is changed, and the fragmentation at the exit port P4 is eliminated. Therefore, the fragmentation is reduced as the whole network 2.

The schedule change unit 125 changes the transmission schedule in each of the plurality of switches SW in accordance with the change of the transmission timing of assumed movable traffic (step S17), when the increase/decrease measurement unit 124 judges that the fragmentation is reduced as the whole network 2. Then, the schedule change unit 125 transmits the transmission schedule after change to each switch via the communication unit 11.

Thus, the control unit 12 changes the transmission schedule in each of the plurality of switches SW, when the transmission timing of movable traffic at the other exit port other than the target exit port is changed in association with the change of the transmission timing of movable traffic at the target exit port, and the transmission timing of movable traffic does not collide with the transmission timing of the other priority traffic and the fragmentation is reduced as the whole network 2.

By changing the transmission schedule in each of the plurality of switches SW so that the fragmentation is reduced as the whole network 2, the time that can be allocated to the transmission of BE traffic increases, so that the control device 10 and the scheduling method according to the present embodiment can improve the efficiency of data transfer in the network 2. In addition, according to the control device 10 and the scheduling method according to the present embodiment, the transmission schedule is changed only when the fragmentation is reduced as the whole network 2, so that the useless change of transmission schedule is reduced and the increase of cost can be suppressed.

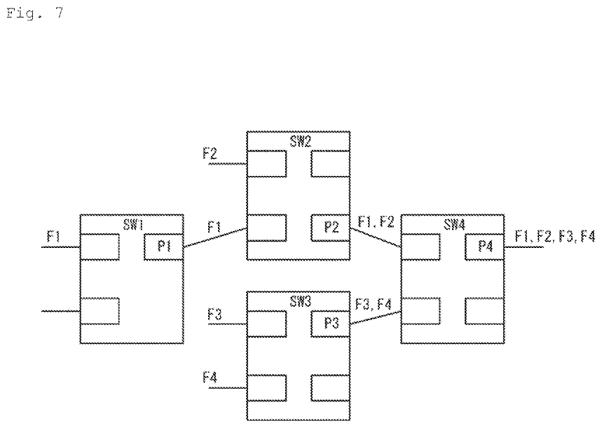

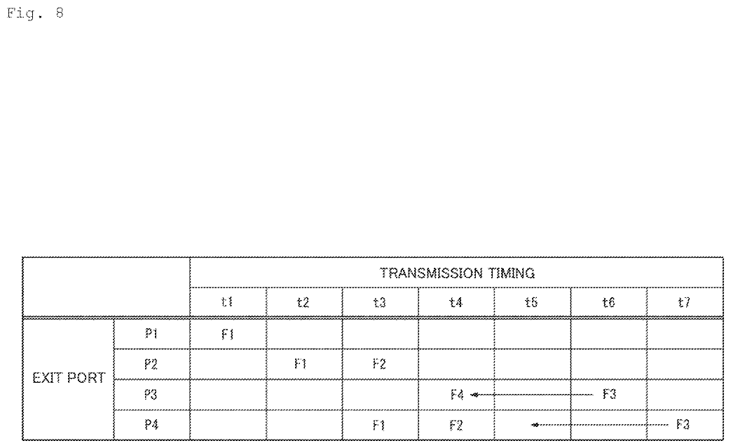

Note that although, in FIG. 6, the description has been performed by using an example in which no collision with the other priority traffic occurs at the (transmission timing t4) of the change destination of the transmission timing of movable traffic at the exit port P3, there is a case where a collision with the other priority traffic occurs at the change destination. For example, it is assumed that the priority traffic F4 is transmitted from the switch SW3 to the switch SW4 in addition to the priority traffic F3 as shown in FIG. 7. Then, the priority traffic F4 is transmitted at the transmission timing t4 from the exit port P3 as shown in FIG. 8. In this case, when the transmission timing of priority traffic F3 at the exit port P3 is changed to the transmission timing t4, the collision occurs between the priority traffic F3 and the priority traffic F4.

The control unit 12 (movable traffic judgement unit 123) may change the transmission timing of movable traffic within a delay range (an allowable range of End-to-End delay) allowed for the movable traffic when changing the transmission timing of movable traffic at the other exit port other than the target exit port in association with the change of the transmission timing of movable traffic at the target exit port.

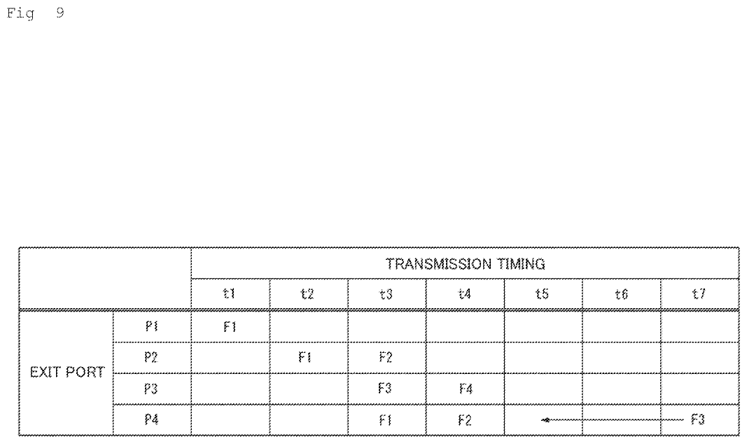

For example, in the example shown in FIG. 8, it is assumed that the priority traffic F3 is allowed to be delayed within a range of transmission timing of two times. In this case, the control unit 12 determines the transmission timing of priority traffic F3 at the exit port P3 within the range (transmission timing t3 or transmission timing t4) of transmission timing two times from the transmission timing t5 after the change of priority traffic F3 at the exit port P4. As shown in FIG. 8, since the transmission of priority traffic is not scheduled at the transmission timing t3 at the exit port P3, as shown in FIG. 9, the control unit 12 determines the transmission timing of priority traffic F3 at the exit port P3 as the transmission timing t3.

Thus, the transmission timing of movable traffic at the other exit port other than the target exit port is changed within the delay range allowed for the movable traffic, so that the flexibility of scheduling is improved and more efficient data transfer is enabled.

Next, a hardware configuration of the control device 10 according to the present embodiment will be described.

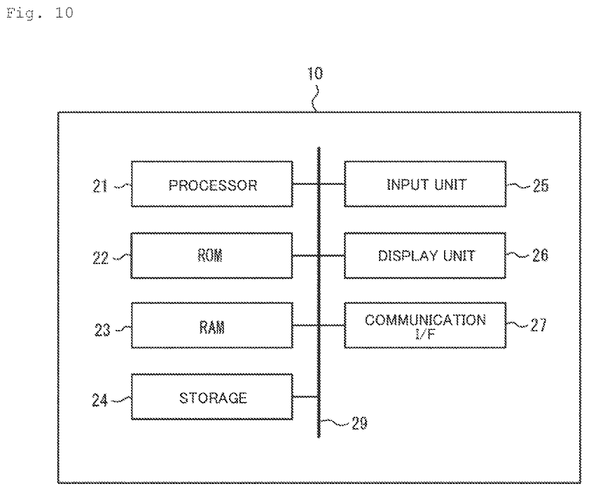

FIG. 10 is a diagram showing one example of a hardware configuration of the control device 10 according to the present embodiment. FIG. 10 shows one example of the hardware configuration of the control device 10 in a case where the control device 10 is configured by a computer capable of executing a program instruction. In this case, the computer may be any of a general-purpose computer, a dedicated computer, a work station, a personal computer (PC), an electronic notepad, or the like. The program instructions may be program codes, code segments, or the like for executing necessary tasks.

As shown in FIG. 10, the control device 10 has a processor 21, a ROM (Read Only Memory) 22, a RAM (Random Access Memory) 23, a storage 24, an input unit 25, a display unit 26, and a communication interface (I/F) 27. The respective components are communicatively connected to each other via a bus 29. Specifically, the processor 21 is a CPU (Central Processing Unit), an MPU (Micro Processing Unit), a GPU (Graphics Processing Unit), a DSP (Digital Signal Processor), an SoC (System on a Chip), and the like and may be configured by a plurality of processors of the same type or different types.

The processor 21 is a control unit that controls each configuration and executes various types of arithmetic processing of the control device 10. That is, the processor 21 reads a program from the ROM 22 or the storage 24 and executes the program using the RAM 23 as a work region. The processor 21 controls each configuration and performs various types of arithmetic processing in accordance with the programs stored in the ROM 22 or the storage 24. In the present embodiment, the ROM 22 or the storage 24 stores the program for causing the computer to function as the control device 10 according to the present disclosure. By reading out and executing the program by the processor 21, each configuration of the control device 10 is realized.

The program may be provided in a form to be stored on a non-transitory storage medium such as a CD-ROM (Compact Disk Read Only Memory), a DVD-ROM (Digital Versatile Disk Read Only Memory), or a USB (Universal Serial Bus) memory. In addition, the program may be provided in a form to be downloaded from an external device via a network.

The ROM 22 stores various programs and various types of data.

The RAM 23 temporarily stores programs or data as the work region. The storage 24 is constituted by an HDD (Hard Disk Drive) or an SSD (Solid State Drive) and stores various programs including an operating system, and various types of data.

The input unit 25 includes a pointing device such as a mouse and a keyboard, and is used for various inputs.

The display unit 26 is, for example, a liquid crystal display, and displays various types of information. The display unit 26 may employ a touch-panel system, and may function as the input unit 25.

The communication interface 27 is an interface for communicating with the other device (for example, switches SW1 to SW4), and is a LAN interface, for example.

The computer can be suitably used in order to function as each unit of the above-described control device 10. Such a computer can realize the functions of each unit of the control device 10 by storing the program describing processing contents for realizing the functions of each unit of the control device 10 in the storage unit of the computer and causing the processor of the computer to read and execute the program. That is, the program can cause the computer to function as the above-described control device 10. In addition, the program can be recorded on a non-temporary recording medium. Further, the program may also be provided via the network.

The following supplement items are further disclosed in relation to the above embodiments.

### Supplement Item 1

A scheduling method of a transmission schedule of priority traffic in a network in which transmission timing by switches is reserved and the priority traffic composed of frame sequences transmitted while guaranteeing the maximum delay is transferred through a plurality of switches includes the steps of
acquiring the transmission schedule of priority traffic in each of the plurality of switches,
judging whether or not there is fragmentation in which an interval equal to or greater than a predetermined value is provided between the transmission timing of one priority traffic and the transmission timing of next priority traffic at an exit port of one switch on the basis of the acquired transmission schedule,
judging whether or not there is movable traffic capable of reducing the interval by performing defragmentation for changing the transmission timing among the priority traffic transmitted at the exit port of the one switch when judging that there is the fragmentation,
judging whether or not the fragmentation is reduced as a whole network by a change in the transmission schedule in each of the plurality of switches along with the change in the transmission timing of movable traffic when judging that there is the movable traffic, and
changing the transmission schedule in each of the plurality of switches when judging that the fragmentation is reduced as the whole network.

### Supplement Item 2

The scheduling method according to Supplement Item 1 includes the step of
judging whether or not there is the fragmentation, when new priority traffic is added, when existing priority traffic is deleted, or regularly.

### Supplement Item 3

The scheduling method according to Supplement Item 1 or 2 includes the step of
judging whether or not there is the fragmentation in order from the exit port having the larger number of scheduled priority traffic.

### Supplement Item 4

The scheduling method according to any one of Supplement Items 1 to 3 includes the step of
judging whether or not the priority traffic is the movable traffic in order from the priority traffic whose transmission timing is separated from an average of the transmission timing of priority traffic transmitted at the exit port of the one switch among the priority traffic transmitted at the exit port of the one switch.

### Supplement Item 5

The scheduling method according to any one of Supplement Items 1 to 4 includes the step of
judging whether or not the priority traffic is the movable traffic for the priority traffic in which the transmission timing is not included in a cluster of the transmission timing of two or more consecutive priority traffic among the priority traffic transmitted from the exit port of the one switch.

### Supplement Item 6

The scheduling method according to any one of Supplement Items 1 to 5 includes the step of
changing the transmission schedule in each of the plurality of switches when the transmission timing of movable traffic at the other exit port other than the exit port of the one switch is changed in association with the change of the transmission timing of movable traffic, however the transmission timing of movable traffic does not collide with the transmission timing of the other priority traffic and the fragmentation is reduced as the whole network.

### Supplement Item 7

The scheduling method according to any one of Supplement Items 1 to 6 includes the step of
changing the transmission timing of movable traffic within a delay range allowed for the movable traffic when changing the transmission timing of movable traffic at the other exit port other than the exit port of the one switch in association with the change of the transmission timing of movable traffic.

### Supplement Item 8

A control device that controls a transmission schedule of priority traffic in a network in which transmission timing by switches is reserved and the priority traffic composed of frame sequences transmitted while guaranteeing the maximum delay is transferred through a plurality of switches, and includes
a control unit, in which
the control unit
judges whether or not there is fragmentation in which an interval equal to or greater than a predetermined value is provided between the transmission timing of one priority traffic and the transmission timing of next priority traffic at an exit port of one switch on the basis of the transmission schedule of priority traffic in each of the plurality of switches,
judges whether or not there is movable traffic capable of reducing the interval by performing defragmentation for changing the transmission timing among the priority traffic transmitted at the exit port of the one switch when judging that there is the fragmentation,
judges whether or not the fragmentation is reduced as a whole network by a change in the transmission schedule in each of the plurality of switches along with the change in the transmission timing of movable traffic when judging that there is the movable traffic, and
changes the transmission schedule in each of the plurality of switches when judging that the fragmentation is reduced as the whole network.

### Supplement Item 9

A program that causes a computer to execute the scheduling method according to any one of Supplement Items 1 to 7.

### Supplement Item 10

A recording medium that records the program according to Supplement Item 9.

Although the above-described embodiments are described as a representative example, it is clear to those skilled in the art that many changes and substitutions can be made within the gist and scope of the present disclosure. Therefore, the present invention should not be interpreted to be limited by the above-described embodiment and the present invention can be modified and changed in various ways without departing from the scope of the claims. For example, a plurality of configuration blocks shown in the configuration diagrams of the embodiments may be combined to one, or one configuration block may be divided.

### REFERENCE SIGNS LIST

1, 1a Communication system
10 Control device
11 Communication unit
12 Control unit
21 Processor
22 ROM
23 RAM
24 Storage
25 Input unit
26 Display unit
27 Communication I/F
29 Bus

1. A scheduling method of a transmission schedule of priority traffic in a network in which transmission timing by switches is reserved and the priority traffic composed of frame sequences transmitted while guaranteeing the maximum delay is transferred through a plurality of switches, the scheduling method comprising:
acquiring the transmission schedule of priority traffic in each of the plurality of switches;
determining whether or not there is fragmentation in which an interval equal to or greater than a predetermined value is provided between the transmission timing of one priority traffic and the transmission timing of next priority traffic at an exit port of one switch on the basis of the acquired transmission schedule;
where there is fragmentation, determining whether there is movable traffic capable of reducing the interval by performing defragmentation for changing the transmission timing among the priority traffic transmitted at the exit port of the one switch;
when there is movable traffic, determining whether the fragmentation is reduced as a whole network by a change in the transmission schedule in each of the plurality of switches along with the change in the transmission timing of movable traffic; and
changing the transmission schedule in each of the plurality of switches when determining that the fragmentation is reduced as the whole network.

2. The scheduling method according to claim 1, further comprising:
determining, whether or not there is the fragmentation, when new priority traffic is added, when existing priority traffic is deleted, or regularly.

3. The scheduling method according to claim 1, further comprising:
determining, whether or not there is the fragmentation in order from the exit port having the larger number of scheduled priority traffic.

4. The scheduling method according to claim 1, further comprising:
determining, whether or not the priority traffic is the movable traffic in order from the priority traffic whose transmission timing is separated from an average of the transmission timing of priority traffic transmitted at the exit port of the one switch among the priority traffic transmitted at the exit port of the one switch.

5. The scheduling method according to claim 1, further comprising:
determining, whether the priority traffic is the movable traffic for the priority traffic in which the transmission timing is not included in a cluster of the transmission timing of two or more consecutive priority traffic among the priority traffic transmitted from the exit port of the one switch.

6. The scheduling method according to claim 1, further comprising:
changing the transmission schedule in each of the plurality of switches when the transmission timing of movable traffic at a second exit port different from the exit port of the one switch is changed in association with the change of the transmission timing of movable traffic, however the transmission timing of movable traffic does not collide with the transmission timing of the other priority traffic and the fragmentation is reduced as the whole network.

7. The scheduling method according to claim 1, further comprising:
changing the transmission timing of movable traffic within a delay range allowed for the movable traffic when changing the transmission timing of movable traffic at the second exit port in association with the change of the transmission timing of movable traffic.

8. A control device that controls a transmission schedule of priority traffic in a network in which transmission timing by switches is reserved and the priority traffic composed of frame sequences transmitted while guaranteeing the maximum delay is transferred through a plurality of switches, the control device comprising:
a control unit, wherein the control unit performs operations comprising:
determine whether there is fragmentation in which an interval equal to or greater than a predetermined value is provided between the transmission timing of one priority traffic and the transmission timing of next priority traffic at an exit port of one switch on the basis of the transmission schedule of priority traffic in each of the plurality of switches,
when there is fragmentation, determine whether there is movable traffic capable of reducing the interval by performing defragmentation for changing the transmission timing among the priority traffic transmitted at the exit port of the one switch,
when there is movable traffic, determine whether the fragmentation is reduced as a whole network by a change in the transmission schedule in each of the plurality of switches along with the change in the transmission timing of movable traffic, and
changes the transmission schedule in each of the plurality of switches when determining that the fragmentation is reduced as the whole network.

9. The scheduling device according to claim 8, wherein the control unit determines whether there is the fragmentation when new priority traffic is added, when existing priority traffic is deleted, or regularly.

10. The scheduling device according to claim 8, wherein the control unit determines whether there is the fragmentation in order from the exit port having the larger number of scheduled priority traffic.

11. The scheduling device according to claim 8, wherein the control unit determines whether priority traffic is the movable traffic in order from the priority traffic whose transmission timing is separated from an average of the transmission timing of priority traffic transmitted at the exit port of the one switch among the priority traffic transmitted at the exit port of the one switch.

12. The scheduling device according to claim 8, wherein the control unit determines whether the priority traffic is the movable traffic for the priority traffic in which the transmission timing is not included in a cluster of the transmission timing of two or more consecutive priority traffic among the priority traffic transmitted from the exit port of the one switch.

13. The scheduling device according to claim 8, further comprising:
the control unit changes the transmission schedule in each of the plurality of switches when the transmission timing of movable traffic at a second exit port different from the exit port of the one switch is changed in association with the change of the transmission timing of movable traffic, however the transmission timing of movable traffic does not collide with the transmission timing of the other priority traffic and the fragmentation is reduced as the whole network.

14. The scheduling method according to claim 8, further comprising:
the control unit changes the transmission timing of movable traffic within a delay range allowed for the movable traffic when changing the transmission timing of movable traffic at the second exit port in association with the change of the transmission timing of movable traffic.

15. A computer-readable non-transitory recording medium storing computer-executable program instructions that when executed by a processor cause a computer to execute a scheduling method comprising:
acquiring the transmission schedule of priority traffic in each of the plurality of switches;
determining whether there is fragmentation in which an interval equal to or greater than a predetermined value is provided between the transmission timing of one priority traffic and the transmission timing of next priority traffic at an exit port of one switch on the basis of the acquired transmission schedule;
when there is fragmentation, determining whether there is movable traffic capable of reducing the interval by performing defragmentation for changing the transmission timing among the priority traffic transmitted at the exit port of the one switch;
when there is movable traffic, determining whether the fragmentation is reduced as a whole network by a change in the transmission schedule in each of the plurality of switches along with the change in the transmission timing of movable traffic; and
changing the transmission schedule in each of the plurality of switches when determining that the fragmentation is reduced as the whole network.

16. The computer-readable non-transitory recording medium according to claim 15 wherein the scheduling processing method further comprises:
determining whether there is the fragmentation, when new priority traffic is added, when existing priority traffic is deleted, or regularly.

17. The computer-readable non-transitory recording medium according to claim 15 wherein the scheduling processing method further comprises:
determining whether there is the fragmentation in order from the exit port having the larger number of scheduled priority traffic.

18. The computer-readable non-transitory recording medium according to claim 15 wherein the scheduling processing method further comprises:
determining whether the priority traffic is the movable traffic in order from the priority traffic whose transmission timing is separated from an average of the transmission timing of priority traffic transmitted at the exit port of the one switch among the priority traffic transmitted at the exit port of the one switch.

19. The computer-readable non-transitory recording medium according to claim 15 wherein the scheduling processing method further comprises:
determining whether the priority traffic is the movable traffic for the priority traffic in which the transmission timing is not included in a cluster of the transmission timing of two or more consecutive priority traffic among the priority traffic transmitted from the exit port of the one switch.

20. The computer-readable non-transitory recording medium according to claim 15 wherein the scheduling processing method further comprises:
changing the transmission schedule in each of the plurality of switches when the transmission timing of movable traffic at a second exit port different from the exit port of the one switch is changed in association with the change of the transmission timing of movable traffic, however the transmission timing of movable traffic does not collide with the transmission timing of the other priority traffic and the fragmentation is reduced as the whole network.
